(19) United States
(12) Patent Application Publication
(10) Pub. No.: US 2023/0161940 A1
(43) Pub. Date: May 25, 2023

(54) ZERO DIFFUSION BREAK

(71) Applicant: Samsung Electronics Co., Ltd., Suwon-si (KR)

(72) Inventors: Andrew Paul HOOVER, Austin, TX (US); Matthew Stephen BERZINS, Cedar Park, TX (US); Gregory Andrew CONSTANT, Buda, TX (US)

(21) Appl. No.: 17/863,382

(22) Filed: Jul. 12, 2022

Related U.S. Application Data
(60) Provisional application No. 63/281,603, filed on Nov. 19, 2021.

(51) Int. Cl. G06F 30/3953; G06F 30/392

(52) U.S. Cl. CPC G06F 30/3953; G06F 30/392

(57) ABSTRACT

A standard cell in a Place and Route (PNR) library of standard cells includes a cell boundary and cell configuration information. The cell boundary includes a first edge and a second edge that is opposite the first edge. The cell configuration information indicates a power connection configuration to be used with a second standard cell when the standard cell is placed next to the second standard cell in a layout in a PNR environment, such that at least one transistor source electrode is physically shared between the standard cell and the second standard cell. The cell configuration information may be edge identifier information for the first edge and/or the second edge of the first standard cell. The power connection configuration may also indicate that the power connection configuration for the first edge and/or the second edge is outside the cell boundary for the standard cell.

### CROSS-REFERENCE TO RELATED APPLICATION

This application claims the priority benefit under 35 U.S.C. § 119(e) of U.S. Provisional Application No. 63/281,603, filed on Nov. 19, 2021, the disclosure of which is incorporated herein by reference in its entirety.

### TECHNICAL FIELD

The subject matter disclosed herein relates to area scaling in semiconductor manufacturing technology. More particularly, the subject matter disclosed herein relates to a standard cell and a technique in a Place and Route environment that shares transistor source (Vdd/Vss) power connections between horizontally placed adjacent standard cells.

### BACKGROUND

Pitch scaling has been used for area scaling for standard cells in a Place And Route (PNR) environment. Aggressive channel-length scaling, however, may not be suitable for all sizes of semiconductor scaling nodes. Wire-pitch scaling has also been used for area scaling; however, wire-pitch scaling tends to result in an increased electrical resistance as the wire-pitch scaling becomes smaller. Design Technology Co-Optimization (DTCO) techniques may continue area scaling as scaling nodes become smaller. DTCO techniques may include practices, such as moving from a double diffusion break (DDB) to a single diffusion break (SDB), using a contact over active gate, using self-aligned metallization with cut masks, using layout techniques that include process and design rule enablement, using stacked logic die, and using backside power network. While some DTCO techniques may provide only a small improvement in area savings, DTCO techniques may be combined to provide a greater total scaling.

### SUMMARY

An example embodiment provides a first standard cell in a PNR library of standard cells in which the first standard cell may include a cell boundary that includes a first edge and a second edge that is opposite the first edge, and cell configuration information that indicates a power connection configuration to be used with a second standard cell when the first standard cell is placed next to the second standard cell in a layout in a PNR environment, such that at least one transistor source electrode is physically shared between the first standard cell and the second standard cell. In one embodiment, the cell configuration information may indicate that the power connection configuration for at least one of the first edge and the second edge is outside the cell boundary for the first standard cell. In another embodiment, the cell configuration information may include edge identifier information for at least one of the first edge and the second edge of the first standard cell. In still another embodiment, when the first standard cell is placed in the layout in the PNR environment, a minimum distance between an outside edge of the first standard cell and an outside edge of the second standard cell is one Contacted Poly Pitch (CPP) for the shared power connection configuration. In yet another embodiment, when the first standard cell is placed in the layout in the PNR environment, the cell boundary of the first standard cell abuts a cell boundary of the second standard cell. In one embodiment, the cell configuration information may indicate that the power connection configuration for at least one of the first edge and the second edge is inside a cell boundary for the second standard cell when the first standard cell is placed next to the second standard cell. In another embodiment, the cell configuration information may indicate that the power connection configuration for the first standard cell is outside of a cell boundary of the first standard cell. In still another embodiment, the library of standards cells may include at least one variant of the first standard cell that is equivalent in function and drive strength to the first standard cell and includes cell configuration information for the variant of the first standard cell that provides a power configuration that is different from the power configuration of the first standard cell. In yet another embodiment, the cell configuration information for the variant of the first standard cell may indicate the power configuration to be inside a cell boundary of the variant of the first standard cell. In one embodiment, the cell configuration information for the first standard cell may indicate that one of the first edge or the second edge is configured as a dummy gate.

An example embodiment provides a PNR library of standard cells that may include a first standard cell that may include: a cell boundary that includes a first edge and a second edge that is opposite the first edge, and cell configuration information that indicates a power connection configuration to be used with a second standard cell of the PNR library of standard cells when the first standard cell is placed next to the second standard cell in a layout in a PNR environment, such that at least one transistor source electrode is physically shared between the first standard cell and the second standard cell. In one embodiment, the cell configuration information may indicate that the power connection configuration for at least one of the first edge and the second edge is outside the cell boundary for the first standard cell. In another embodiment, the cell configuration information may include edge identifier information for at least one of the first edge and the second edge of the first standard cell. In still another embodiment, when the first standard cell is placed in the layout in the PNR environment, a minimum distance between an outside edge of the first standard cell and an outside edge of the second standard cell is one CPP for the shared power connection configuration. In yet another embodiment, when the first standard cell is placed in the layout in the PNR environment, the cell boundary of the first standard cell abuts a cell boundary of the second standard cell. In one embodiment, the cell configuration information may indicate that the power connection configuration for at least one of the first edge and the second edge is inside a cell boundary for the second standard cell when the first standard cell is placed next to the second standard cell. In another embodiment, the cell configuration information may indicate that the power connection configuration for the first standard cell is outside of a cell boundary of the first standard cell. In still another embodiment, the library of standards cells may further include at least one variant of the first standard cell that is equivalent in function and drive strength to the first standard cell and includes cell configuration information for the variant of the first standard cell that provides a power configuration that is different from the power configuration of the first standard cell. In yet another embodiment, the cell configuration information for the variant of the first standard cell may indicate the power configuration to be inside a cell boundary of the variant of the first standard cell. In one embodiment, the cell configuration information for the first standard cell may indicate that one of the first edge or the second edge is configured as a dummy gate.

An example embodiment provides a first standard cell in a PNR library of standard cells in which the first standard cell may include: a cell boundary that includes a first edge and a second edge that is opposite the first edge, cell configuration information that indicates that a power connection configuration for at least one of the first edge and the second edge is outside the cell boundary for the first standard cell in a PNR environment, and a transistor source connection for the first standard cell which is outside the cell boundary. In one embodiment, the cell configuration information may indicate the power connection configuration that is shared with a second standard cell when the first standard cell is placed next to the second standard cell in a layout in the PNR environment. In another embodiment, when the first standard cell is placed in the layout in the PNR environment, a minimum distance between the outside edge of the first standard cell and an outside edge of the second standard cell is one CPP for the shared power connection configuration. In still another embodiment, the cell configuration information may include edge identifier information for at least one of the first edge and the second edge of the first standard cell. In yet another embodiment, when the first standard cell is placed in a layout in the PNR environment, the cell boundary of the first standard cell abuts a cell boundary of a second standard cell. In one embodiment, the cell configuration information may indicate that the power connection configuration for at least one of the first edge and the second edge is inside a cell boundary for a second standard cell. In another embodiment, a second standard cell may include cell configuration information associated with the second standard cell, and the cell configuration information for the second standard cell may indicate that a power connection configuration for the second standard cell is outside of a cell boundary of the second standard cell. In still another embodiment, the library of standards cells may include at least one variant of the first standard cell that is equivalent in function and drive strength to the first standard cell and may include cell configuration information for the variant of the first standard cell that provides a power configuration that is different from the power configuration of the first standard cell. In yet another embodiment, the cell configuration information for the variant of the first standard cell may indicate the power configuration to be inside a cell boundary of the variant of the first standard cell. In one embodiment, the cell configuration information for the first standard cell may indicate that one of the first edge or the second edge is configured as a dummy gate.

### BRIEF DESCRIPTION OF THE DRAWING

In the following section, the aspects of the subject matter disclosed herein will be described with reference to exemplary embodiments illustrated in the figure, in which:

FIG. 1 depicts a plan view of an example traditional NAND 2 logic gate standard cell;

FIG. 2 depicts an example of how an instance of the example traditional NAND 2 logic gate standard cell of FIG. 1 would be abutted to other instances of NAND 2 logic gate standard cells in a PNR environment;

FIG. 3 depicts an example embodiment of how two abutting instances of NAND 2 logic gate standard cells in a PNR environment may utilize Zero Diffusion Breaks (ZDB) according to the subject matter disclosed herein;

FIG. 4 depicts two variants of a NAND2 logic gate standard cell in which each variant includes edge identifiers to implement ZDB according to the subject matter disclosed herein;

FIG. 5 provides a visual display of permissible and impermissible ZDB edge abutment configurations according to the subject matter disclosed herein;

FIG. 6 depicts two example embodiments of logic gates that may include multiple variant abstracted views according to the subject matter disclosed herein;

FIG. 7 depicts the example embodiment of the INVD2 logic gate shown in FIG. 6 and the five possible abstracted variant views shown to the right;

FIG. 8 shows example cell abutment configurations that are permitted in which cells include a ZDB_PwrOutside edge identifier according to the subject matter disclosed herein; and

FIG. 9 depicts an electronic device that in one embodiment may include components and/or modules that are formed using standard cells that have at least one ZDB edge identifier according to the subject matter disclosed herein.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The subject matter disclosed herein provides a Zero Diffusion Break (ZDB) in a PNR environment that allows standard cells to share power connections on the left and/or right edges of a cell with an adjacent cell, thereby reducing the design area and design cost. As used herein, the phrase “sharing a power connection” means that both pmos and nmos sources on adjacent cell edges are respectively connected to Vdd and Vss, in such a way that there is no diffusion break or dummy transistor at the ZDB boundary.

The term “PNR tool” is used herein to describe any automated tool which performs standard cell placement and routing between standard cells. However, it is understood that the subject matter disclosed herein also applies to an automated tool that performs standard cell placement but does not perform routing between standard cells.

Some PNR tools may use a boundary identifier. A boundary identifier that may include a boundary layer or an identification in a physical cell library format, such as Library Exchange Format (LEF). In the one case, the LEF construct ‘SIZE’ may indicate an X and a Y size of the cell. In this case, relative to the cell, the left edge identifier may be at X=0, and the right edge may be at the X size identified in the LEF. Boundary identifiers may also be identified in other ways. For example, coordinates of each corner of a shape on a cell outline layer or boundary layer may be used to define the boundary identifier. In some cases, the boundary of a cell may not be a simple rectangle. For example, a standard cell may be multiple rows tall. For example, if a cell is 2 rows tall, the width of the bottom row of the cell may be different from the width of the top row of the cell. In this case, the left edge of the cell may have 2 left edge boundary identifiers (one for the bottom row of the cell and one for the top row of the cell), and similarly may have 2 right edge boundary identifiers. Herein, the term “boundary identifier,” or just “boundary”, shall include any of the multiple ways to specify such boundary identifier.

A boundary identifier for a cell may align with the centerline of the transistor gates (a.k.a. “poly”) in the left and/or right sides of the cell, particularly in a “single diffusion break” or SDB process. In a traditional SDB process, the boundary may include dielectric isolation between the left and right cells. Alternatively, in a traditional SDB process, the boundary may include a dummy transistor which is connected so that it is turned off, achieving electrical isolation between left and right cells. Other configurations are possible, such as nmos using dielectric isolation and pmos using electrical isolation, or vice-versa. For simplicity, any method (dielectric, electrical, or a combination, or other methods) used to isolate a transistor in one cell from a transistor in an adjacent cell will herein be generally referred to as “SDB”. In a traditional SDB process, “dummy gates” or “dummy gate electrodes” generally refer to a drawn shape on the edge of a standard cell that isolates the standard cell from neighboring standard cells. Because these dummy gates are only for isolation, they do not perform a logic function. In a particular semiconductor process, these dummy gates can provide electrical isolation or dielectric isolation.

Abstracted (example: LEF) cells in a PNR environment may have abutting boundaries, but may not be allowed to have overlapping boundaries. In contrast to traditional LEF cells in a PNR environment, as disclosed herein a standard cell that includes a ZDB may include transistor power connections that overlap between adjacent standard cells. Accordingly, LEF standard cells may be created that include one or more ZDBs in which transistor power connections in a detailed layout view lie outside the cell boundary of the standard cell. A detailed layout view may include all cell layout information, whereas an abstracted layout view (such as LEF) may omit some of the layers found in the detailed layout view. Multiple formats exist for detailed layout views, with 2 examples being GDS2 (Graphics Design System II often referred to simply as GDS), and OASIS (Open Artwork System Interchange Standard). As described herein, for simplicity the term “GDS” will be used to describe the detailed layout view. It is understood that this is for simplicity, and not limiting, and that any detailed layout view format may be used. Similarly, the term “LEF” is used herein to describe the abstracted (or “abstract”) view of the standard cell used for PNR for simplicity. It is understood that this is not limiting, and that any abstract view format may be used. In some cases, a PNR tool may alternatively use a detailed layout view including associated boundary identifiers instead of an abstracted view. The subject matter disclosed herein does not depend on whether a PNR tool uses an abstract or detailed layout view. For simplicity, the exemplary embodiments contained herein may assume that a PNR tool uses an abstracted view. Information, sometimes referred to as edge identifiers, may be associated with a standard cell that may indicate which cell edges (left and/or right, or neither) may be placed next to other cell edges in the library by a PNR tool. Variants of standard cells may have the same GDS layout except for the boundary identifier, but may have different edge identifiers, thereby enabling flexible placement options between the different variant standard cells.

As disclosed herein, horizontally abutting standard cells that include a ZDB may be placed and routed so that Vdd/Vss source connections of the abutting cells overlap with no dummy gate electrode or diffusion break between the two cells and the Vdd/Vss source connections may be shared between the two abutting cells. Accordingly, each cell of the abutting pair of cells may have a corresponding edge identifier that indicates whether abstract layouts of the cell can abut. Area savings may be achieved when an edge in which Vdd/Vss power connections are inside the cell boundary abuts an edge of a cell in which Vss/Vss connections are outside the cell boundary. The detailed GDS layouts for each of the abutting pair of cells may have overlapping Vdd/Vss connections, but the boundary identifiers in the abstract/LEF layout views may not overlap.

In one example embodiment disclosed herein, a standard cell library for a PNR environment may include first and second standard cells. The first standard cell may be associated with first and second edge identifiers. Similarly, the second standard cell may be associated with first and second edge identifiers. Each respective edge identifier may be associated with a different edge in a corresponding standard cell in which the different edges are opposite each other in the standard cell. The PNR environment may use the edge identifiers to place cells adjacent to each other so that transistor power connections at the edge of the first cell and the edge of the second cell may be shared, and so that there are no dummy gate electrodes that separate the first cell and the second cell.

In another embodiment, the standard cell library may include multiple cells that are functionally equivalent with the same drive strength, but differ in cell size and edge identifier(s). In another embodiment, a first edge identifier of a first standard cell may indicate that power connections on a first edge of the first cell are inside a cell boundary of the first cell, and a second edge identifier of a second standard cell may indicate that power connections on a second edge of the second cell are outside a cell boundary of the second cell. In this example embodiment, the first edge of the first cell may be abutted to the second edge of the second cell, thereby allowing the first and second cells to share power connections to transistors at the abutting edges of the first and second cells. In still another embodiment, a standard cell may include an edge identifier indicating that a dummy gate at the edge of the cell. In yet another example embodiment, different standard cells may include different combinations of edge identifiers that indicate power connections inside a cell boundary, outside a cell boundary or a dummy gate at the edge of a cell.

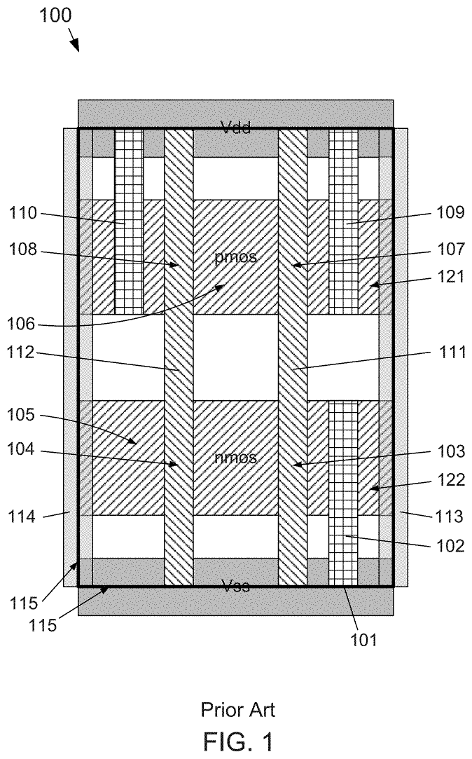

FIG. 1 depicts a plan view of an example traditional NAND 2 logic gate standard cell 100. Not all layers of the standard cell 100 are shown in FIG. 1. The NAND 2 logic gate standard cell 100 includes two nmos transistors connected in series and two pmos transistors connected in parallel. The two nmos transistors are connected in series starting at ground (Vss) at 101 through a power connection 102, and through an nmos transistor 103 and through an nmos transistor 104 to the drain of the transistor 104 at 105. A metal connection (not shown) connects the drain 105 of the nmos transistor 104 to the drains 106 of pmos transistors 107 and 108, which are connected in parallel to Vdd through local interconnect connections 109 and 110. The power rails Vss and Vdd may be located at a lower metal layer. Inputs to the transistors 103, 104, 107 and 108 may be made through gate electrodes 111 and 112. The source electrodes 122 and 121 are indicated for transistors 103 and 107, respectively.

Single diffusion breaks (SDBs) are depicted at 113 and 114. In one embodiment, one or both of the SDBs 113 and 114 may be formed to provide dielectric isolation, as is depicted in FIG. 1. Alternatively, one or both of the SDBs 113 and 114 may provide electrical isolation using off-state transistors.

The standard cell 100 includes a cell outline 115 that is indicated by a relatively heavy line. The cell outline 115 may not necessarily contain all of the shapes of the standard cell 100. For example, part of both SDBs 113 and 114 are depicted as being outside of the standard cell 100. Whenever a Place and Route (PNR) tool operates on a cell outline of a standard cell, such as cell outline 115, the PNR tool basically “sees” the cell outline 115 and metal connections that connect to the cell, but often does not “see” some of the detailed layout inside the cell.

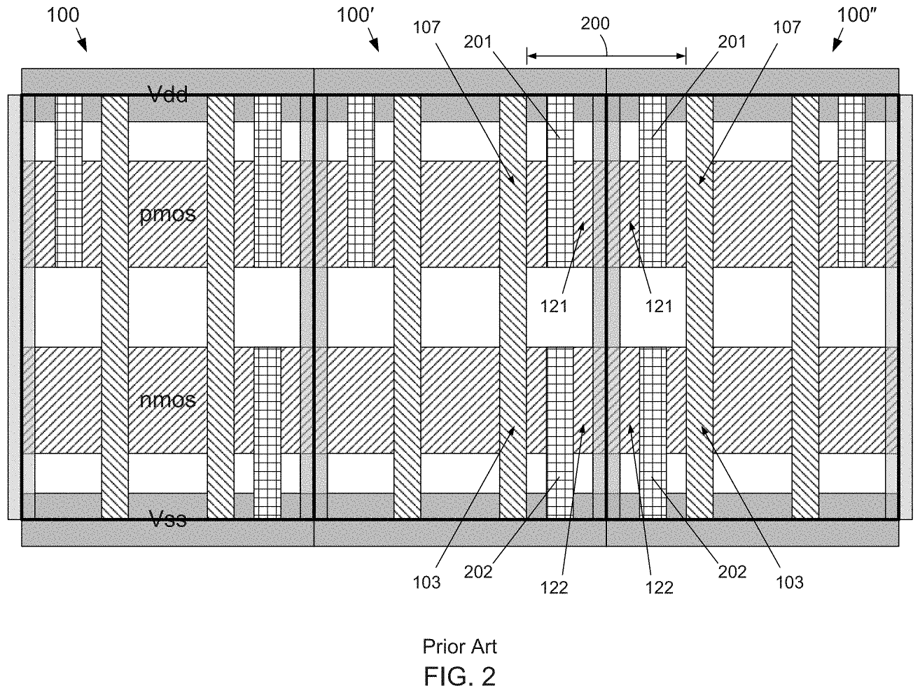

FIG. 2 depicts an example of how an instance of the example traditional NAND 2 logic gate standard cell 100 of FIG. 1 would be abutted to other instances of NAND 2 logic gate standard cells in a PNR environment. As depicted in FIG. 2, a first instance of the standard cell 100 is positioned as the leftmost cell. A second instance of the standard cell 100′ is positioned in the middle, and a third instance of the standard cell 100″ is positioned as the rightmost cell. The instances of standard cells 100 and 100′ are depicted in the PNR RO orientation (not flipped or rotated), whereas the instance of the standard cell 100″ is depicted in a PNR MY orientation because it has been flipped around a vertical axis of the figure.

At the boundary of the instances of cells 100′ and 100″ where the two cell instances abut, the two cell instances have the same power connections 201 and 202 to Vdd and Vss, respectively. Accordingly, the subject matter disclosed herein provides that the region 200 where the two cell instances abut provides an opportunity for area reduction and transistor power connections may be merged. Specifically, the left and right transistor power connections 201 may be merged, and the left and right transistor power connections 202 may be merged. This will result in the two transistor sources 121 being shared as a single source electrode to provide Vdd to both the left transistor 107 and the right transistor 107. Similarly, the two transistor sources 122 will be shared as a single source electrode to provide Vss to both the left transistor 103 and the right transistor 103. It should be understood, however, that the merging of the regions of cell instances that have similar power connections is not limited to NAND standard cells. Other standard cells, such as but not limited to, NOR standard cells and inverter (INV) standard cells, may also have areas that may be merged according to the subject matter disclosed herein. Any standard cell that has power connections on both Vdd and Vss on the same edge of the standard cell may have areas that may be merged. These may further include, but are not limited to, XNOR/XOR cells, BUF cells, AOI/OAI/AO/OA cells, adder cells, mux cells, latches, flip flops, clock gating cells, etc.

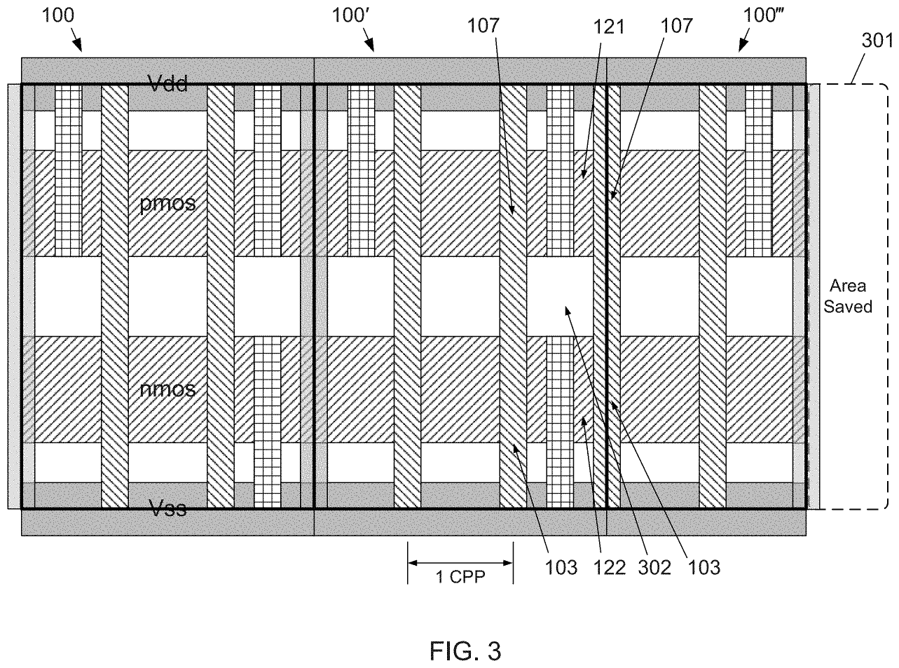

FIG. 3 depicts an example embodiment of how two abutting instances of NAND 2 logic gate standard cells in a PNR environment may utilize Zero Diffusion Breaks (ZDBs) according to the subject matter disclosed herein. As depicted, the instance of the cell 100″ in FIG. 2 is shifted to the left by one contacted poly pitch (CPP), i.e., the distance between two poly lines, to become an instance of a cell 100′. One CPP is indicated towards the bottom of FIG. 3 and may currently be on the order of 50 nm. It should be understood, however, that the subject matter disclosed herein is not constrained to 1 CPP being 50 nm because ZDBs may scale accordingly as the technology scales. The term “CPP” used herein refers to the pitch of transistor gate electrodes, even in technologies where the gate electrode is constructed from a material other than polysilicon (“poly”), such as a metal gate. The term “CPP” used herein refers to the CPP value being used by the standard cell library that ZDB is applied to.

When the instance of the cell 100″ is shifted left by 1 CPP to become cell instance 100″, the rightmost power connections indicated at 201 and 202 in FIG. 2 may be eliminated. As a result, there is a shared power and ground connection between the instances of cell instance 100′ and cell instance 100′″. The area saved by using a ZDB is indicated at 301 in FIG. 3, which may be referred to herein as 1 CPP of area. More specifically, the area saved in this case can be computed as 1 CPP times the height of a standard cell row. It should be noted that there is no SDB between the instances of cell 100′ and cell 100′″ at 302. Note that the left transistor 107 and the right transistor 107 now physically share a single source electrode 121, and that the left transistor 103 and the right transistor 103 now physically share a single source electrode 122.

Traditional PNR tools use an abstract view of standard cells that may not have all of the layers of a standard cell and only some layers may appear in the abstract view. The Library Exchange Format (LEF) is an example that provides an abstract view of a standard cell, whereas the Graphics Data Stream (GDS) is an example of a layout format that provides a detailed layout of a cell. An abstract view typically includes a boundary identifier that may be a shape on an outline layer or a statement of a size of a cell. For example, the LEF assumes that the lower left of a cell instance is the origin (0,0) and there are horizontal (x) and vertical (y) sizes for a cell instance. In an SDB process, the boundary identifier aligns with a center line of the transistor gates (also referred to as poly lines). The Vdd and Vss power rails go outside of the boundary and may be half in a cell and half out of the cell. Overlapping boundaries of LEF cells are not permitted in a PNR environment.

According to the subject matter disclosed herein, abstract views of standard cells that use ZDBs have power connections that are outside the boundaries of the cells. Further, abstracts of standard cell instances include information that indicate which cell edges may be placed next to other cell edges in the library. In one embodiment, edge identifiers are used to indicate which cell edges may be placed next to other cell edges in the library, and may be used with PNR tools that allow edge identifiers to be used. Abstracts of cells may, for example, be input to a PNR tool and commands may be run that indicate the left and right edge identifiers of a cell. Different variants of a standard cell that provides a particular function may have different edge identifiers.

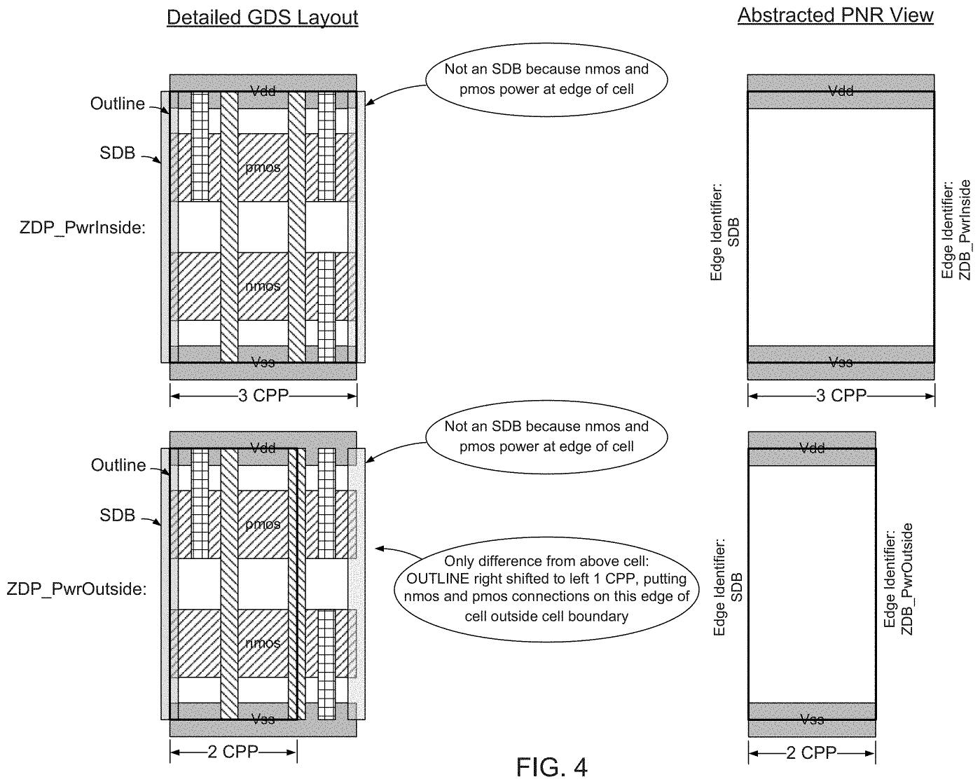

FIG. 4 depicts two variants of a NAND2 logic gate standard cell in which each variant includes a ZDB edge identifier according to the subject matter disclosed herein. Detailed GDS layout views are shown on the left side of FIG. 4, and abstracted PNR views are shown on the right side of FIG. 4. The top NAND2 logic gate is configured to include power connections that are inside the outline shape. The example reference nomenclature for the edge identifier for the right edge of the top NAND2 logic gate is ZDB_PwrInside, which indicates that the top NAND2 logic gate supports ZDB and that the power connections are inside the outline of the top NAND2 logic gate cell. The bottom NAND2 logic gate is configured to include power connections that are outside the outline shape. The example reference nomenclature for the edge identifier for the right edge of the bottom NAND2 logic gate is ZDB_PwrOutside, which indicates that the bottom NAND2 logic gate supports ZDB and that the power connections are outside the outline of the bottom NAND2 logic gate cell. The left edges of both NAND2 gates have the edge identifier SDB.

Note that the right edge of both the top and bottom NAND2 gates in FIG. 4 does not include an SDB shape. Rather, a gate electrode which is not used for isolation is used. When ZDB cells overlap transistor power connections, this gate electrode will be used for an active logic transistor in one of the two abutting cells. Because the transistors source/drains on the left edge of the NAND gates do not both connect to power (VSS does not connect to nmos source/drain on the left edge of the cell), ZDB is not implemented on the left edge of the cell, and a traditional SDB is used for the left edge of the cell.

In FIG. 4 and other figures herein, the outline shape will be used to represent the cell boundary identifier for the abstracted PNR view. The boundary identifier or cell boundary is used by a PNR tool to determine how to place cells. The outline shape for the upper NAND2 logic gate has a width, defined by the left edge to the right edge of the outline, of 3 CPP. The detailed layout view, represented in a file format such as GDS, includes all of the details of the layers within the upper NAND2 logic gate. The lower NAND2 logic gate includes the exact same shapes as the upper NAND2 logic gate and would have the detailed layout view, but with one difference. That is, the difference would be the width of the lower NAND2 logic gate as 2 CPP, as defined by the outline shape.

On the right side of FIG. 4, abstracted PNR views are shown for the same two NAND2 logic gates. The abstracted views provide a boundary of the cell. The abstracted view of the upper NAND2 logic gate is 3 CPPs wide, whereas the lower NAND2 logic gate is 2 CPPs wide. Power rails are shown in both abstracted views. There may also be other information in the abstracted view such as signal connection shapes that are not shown in FIG. 4. Both abstracted views include edge identifiers. A PNR tool uses the edge identifiers to determine which cells can abut. An abstracted view may include information that identifies characteristics of particular edges of a cell, or this information may be provided to a PNR tool separate from the abstracted view. The left edge for both abstracted views includes a SDB edge identifier. For the upper NAND2 logic gate, the right edge identifier for the abstracted view is ZDB_PwrInside, which means that the power connections for the pmos and the nmos transistors at the right edge of the cell are inside the cell outline for the cell. For the abstracted view of the bottom NAND2 logic gate, the right edge identifier is ZDB_PwrOutside, which means that the power connections for pmos and the nmos transistors at the right edge of the cell are outside of the cell outline for the cell.

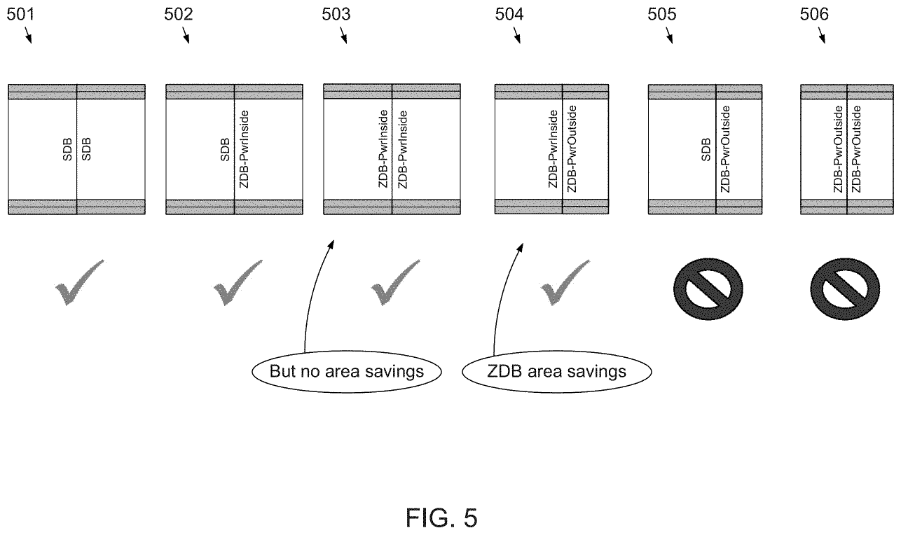

Table 1 sets forth permissible and impermissible ZDB edge abutment configurations. FIG. 5 provides a visual display of permissible and impermissible ZDB edge abutment configurations respectively indicated by checkmarks for permissible ZDB edge abutment configurations or empty circles with a line for impermissible ZDB edge abutment configuration.

TABLE 1
ZDB Edge Abutment Configurations

| | SDB | ZDB_PwrInside | ZDB_PwrOutside |
|---|---|---|---|
| SDB | Yes | Yes | No |
| ZDB_PwrInside | Yes | Yes | Yes |
| ZDB_PwrOutside | No | Yes | No |

From Table 1, a SDB edge may abut another SDB edge, which is a traditional edge abutment configuration and is depicted at 501 in FIG. 5. A SDB edge identifier may also abut with a ZDB_PwrInside edge identifier, which is depicted at 502. This particular configuration results in a traditional SDB isolation in which one cell provides the SDB. A ZDB_PwrInside edge identifier may abut with another ZDB_PwrInside edge identifier, which is depicted at 503, but provides no area savings. For this particular ZDB abutment configuration, a floating poly (or floating gate) may be the result of such an abutment, which may then involve further design and layout considerations.

A ZDB_PwrInside edge identifier may abut with a ZDB_PwrOutside edge identifier, which is depicted at 504. This ZDB edge abutment configuration provides an area savings of 1 CPP. More specifically, while the average area savings per cell for the two cells depicted at 504 is ½ CPP per cell, cells can only be shifted by an integer number of CPPs, so the area savings of 1 CPP is attributed to only one cell because cells can only be shifted by an integer number of CPPs.

Edge abutment configurations indicated at 505 and 506 in FIG. 5 are not allowed. A ZDB_PwrOutside edge identifier may not abut with a SDB edge identifier (depicted at 505) because the SDB would disconnect required power connections to at least one active transistor in the cell with the ZDB_PwrOutside edge. A ZDB_PwrOutside edge identifier may similarly not abut with another ZDB_PwrOutside edge identifier. For this ZDB abutment configuration, depicted at 506, each NAND gate includes four transistors and the abutment configuration would not result in four transistors for each NAND gate.

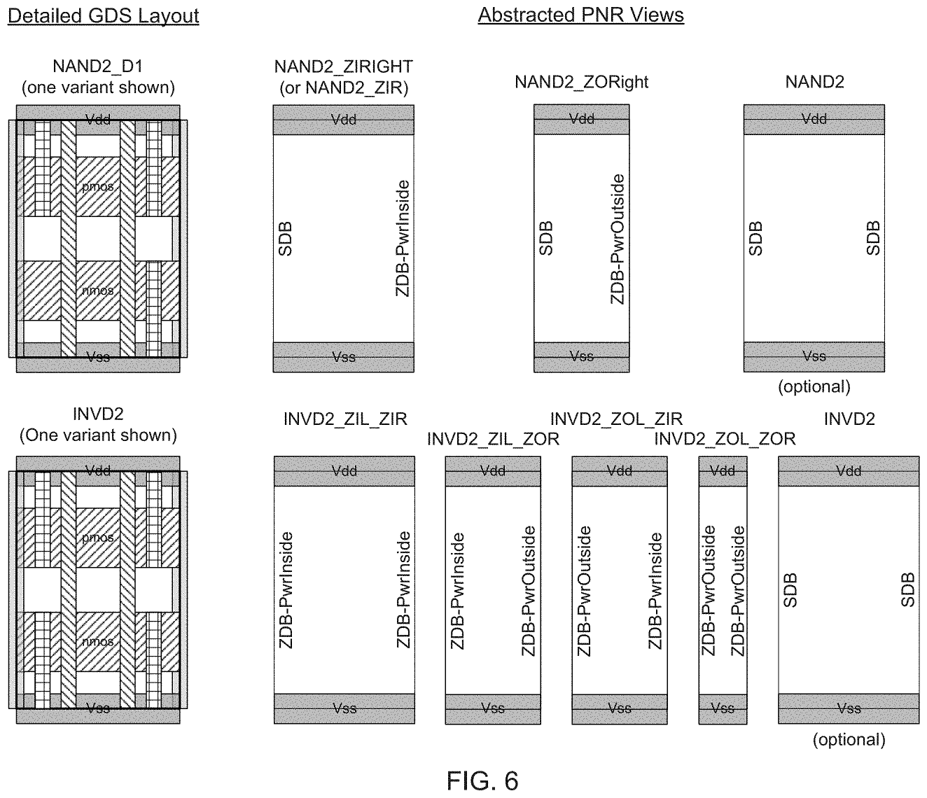

FIG. 6 depicts two example embodiments of logic gates that may include multiple variant abstracted views according to the subject matter disclosed herein. At the top left of FIG. 6, a GDS view of a single variant of a NAND2 logic gate standard cell having a drive level 1 (D1) is shown with three possible abstracted variant views to the right. At the bottom left of FIG. 6, a GDS view of a single variant of an INVD2 logic gate standard cell having a drive level 2 (D2) is shown with five possible abstracted variant views shown to the right. For the different abstracted views of both logic gates, each abstracted view includes edge identifiers that indicate to a PNR tool which edges may be abutted to edges of other cells. In an alternative embodiment, an abstracted view of a standard cell may include information that identifies the characteristics of one or more particular edges of a cell. In another embodiment, the edge identifiers may be provided to the PNR tool separate from the abstracted views. The abstracted variant indicated as “Optional” represents the traditional SDB abstracted view for the standard cell. It should also be noted that for cells having ZDB_PwrOutside edge identifiers, the cell outline moves from that edge toward the center of the cell by 1 CPP. Additionally, there may be more cells in a library that may be able to take advantage of having a ZDB on one side that on two sides. Yet another aspect that should be noted is that the respective edges of cells that abut should have power connections on the right and left sides of the cells to be able to use a ZDB. If, for example, a cell has a signal node on an edge instead of a power connection, there may likely be a conflict between the signal node on that edge and a power connection of the next cell if a ZDB overlap were attempted on that edge.

For the NAND2 logic gate, the leftmost abstracted variant includes a SDB left edge identifier and a ZDB_PwrInside right edge identifier. The next abstracted variant to the right includes a SDB left edge identifier and a ZDB_PwrOutside right edge identifier. The rightmost abstracted variant for the NAND2 logic gate includes a SDB left edge identifier and a SDB right edge identifier.

For the INVD2 logic gate, the left most abstracted variant includes a ZDB_PwrInside left edge identifier and a ZDB_PwrInside right edge identifier. The next abstracted variant to the right includes a ZDB_PwrInside left edge identifier and a ZDB_PwrOutside right edge identifier. The abstracted variant in the middle includes a ZDB_PwrOutside left edge identifier and a ZDB_PwrInside right edge identifier. The fourth abstracted variant includes a ZDB_PwrOutside for both the left and right edge identifiers. The rightmost abstracted variant includes a SDB left edge identifier and a SDB right edge identifier.

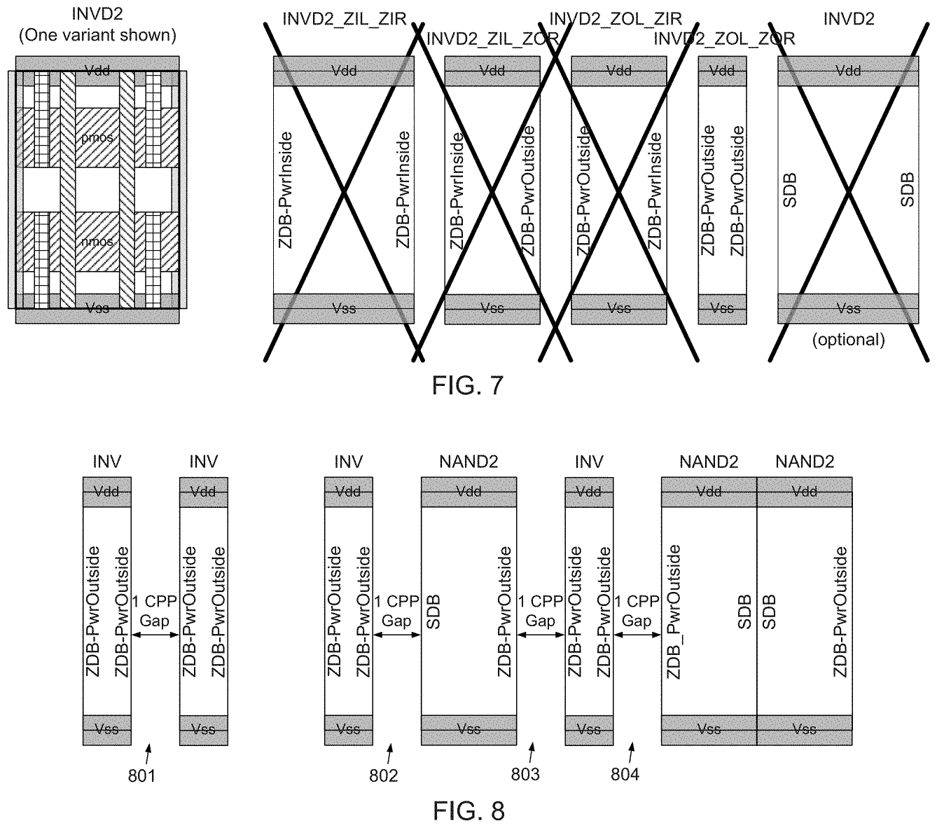

FIG. 7 depicts the example embodiment of the INVD2 logic gate shown in FIG. 6 and the five possible abstracted variant views shown to the right. For a minimal library embodiment, only the abstracted variant view having ZDB_PwrOutside edge identifiers for both left and right edges would be used because the actual implementation of that cell is 1 CPP wide. Cell abutment configurations that result in an area savings occur when a cell having a power outside edge is next to another cell having a corresponding power outside edge and there would be a 1 CPP gap between two cell boundaries. The 1 CPP gap allows for the outside-of-boundary transistor power connections for both cells and is a PNR consideration. The 1 CPP gap would correspond to a 2 CPP gap in a traditional SDB design.

Table 2 summarizes possible cell abutment configurations for cells having SDB and ZDB_PwrOutside edge identifiers for the minimal library embodiment. In this embodiment, there may be 2 values for edge identifiers: SDB and ZDB_PwrOutside.

TABLE 2

| | SBD | ZDB_PwrOutside |
|---|---|---|
| SDB | Yes | No (Need 1 CPP gap) |
| ZDB_PwrOutside | No (Need 1 CPP gap) | No (Need 1 CPP gap) |

FIG. 8 shows for example cell abutment configurations that are permitted in which one cell includes a ZDB_PwrOutside edge identifier according to the subject matter disclosed herein and the minimal library embodiment. At 801, two example INV logic cells having ZDB_PwrOutside edge identifiers are shown with a 1 CPP gap between the two logic cells. If traditional SDB had been used (without ZDB), this gap would have been 2 CPP, so an area savings of 1 CPP is achieved in this case. At 802, an example INV logic cell and an example NAND2 are shown with a 1 CPP gap between the two logic cells. The INV logic cell includes ZDB_PwrOutside left and right edge identifiers, whereas the NAND2 logic cell includes a SDB left edge identifier, similar to 801. At 803, the abutting edges of the two cells both have ZDB_PwrOutside edge identifiers. At 804, the INV logic cell includes a ZDB_PwrOutside left and right edge identifiers, and the NAND2 logic cell includes a ZDB_PwrOutside left edge identifier. Area savings over traditional SDB is achieved in 801, 803, and 804.

In an alternative embodiment, edges could be identified by the presence or absence of a single identifier value. For example, the presence of an SDB identifier could mean an SDB edge, whereas the absence of an SDB identifier could mean a ZDB_PwrOutside edge.

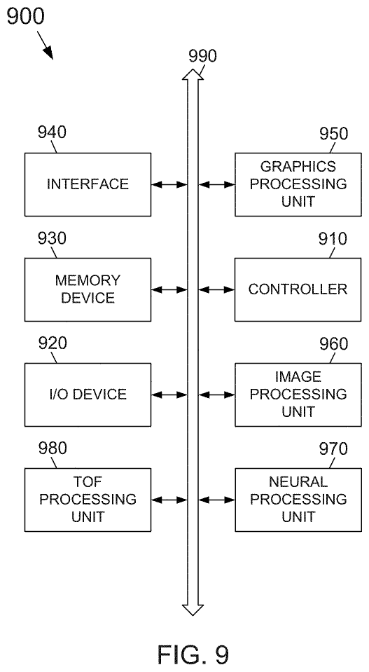

FIG. 9 depicts an electronic device 900 that in one embodiment may include components and/or modules that are formed using standard cells that have at least one ZDB edge identifier according to the subject matter disclosed herein. The electronic device 900 may include a controller (or CPU) 910, an input/output device 920 such as, but not limited to, a keypad, a keyboard, a display, a touch-screen display, a 2D image sensor, a 3D image sensor, a memory 930, an interface 940, a GPU 950, an imaging-processing unit 960, a neural processing unit 970, a TOF processing unit 980 that are coupled to each other through a bus 990. The controller 910 may include, for example, at least one microprocessor, at least one digital signal processor, at least one microcontroller, or the like. The memory 930 may be configured to store a command code to be used by the controller 910 and/or to store a user data.

The interface 940 may be configured to include a wireless interface that is configured to transmit data to or receive data from, for example, a wireless communication network using a RF signal. The wireless interface 940 may also include, for example, an antenna. The electronic system 900 also may be used in a communication interface protocol of a communication system, such as, but not limited to, Code Division Multiple Access (CDMA), Global System for Mobile Communications (GSM), North American Digital Communications (NADC), Extended Time Division Multiple Access (E-TDMA), Wideband CDMA (WCDMA), CDMA2000, Wi-Fi, Municipal Wi-Fi (Muni Wi-Fi), Bluetooth, Digital Enhanced Cordless Telecommunications (DECT), Wireless Universal Serial Bus (Wireless USB), Fast low-latency access with seamless handoff Orthogonal Frequency Division Multiplexing (Flash-OFDM), IEEE 802.20, General Packet Radio Service (GPRS), iBurst, Wireless Broadband (WiBro), WiMAX, WiMAX-Advanced, Universal Mobile Telecommunication Service—Time Division Duplex (UMTS-TDD), High Speed Packet Access (HSPA), Evolution Data Optimized (EVDO), Long Term Evolution—Advanced (LTE-Advanced), Multichannel Multipoint Distribution Service (MMDS), Fifth-Generation Wireless (5G), Sixth-Generation Wireless (6G), and so forth.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

1. A first standard cell in a Place and Route (PNR) library of standard cells, the first standard cell comprising:
a cell boundary that includes a first edge and a second edge that is opposite the first edge; and
cell configuration information that indicates a power connection configuration to be used with a second standard cell when the first standard cell is placed next to the second standard cell in a layout in a PNR environment, such that at least one transistor source electrode is physically shared between the first standard cell and the second standard cell.

2. The first standard cell of claim 1, wherein the cell configuration information indicates that the power connection configuration for at least one of the first edge and the second edge is outside the cell boundary for the first standard cell.

3. The first standard cell of claim 1, wherein the cell configuration information comprises edge identifier information for at least one of the first edge and the second edge of the first standard cell.

4. The first standard cell of claim 1, wherein when the first standard cell is placed in the layout in the PNR environment, a minimum distance between an outside edge of the first standard cell and an outside edge of the second standard cell is one Contacted Poly Pitch (CPP) for the shared power connection configuration.

5. The first standard cell of claim 1, wherein when the first standard cell is placed in the layout in the PNR environment, the cell boundary of the first standard cell abuts a cell boundary of the second standard cell.

6. The first standard cell of claim 1, wherein the cell configuration information indicates that the power connection configuration for at least one of the first edge and the second edge is inside a cell boundary for the second standard cell when the first standard cell is placed next to the second standard cell.

7. The first standard cell of claim 1, wherein the cell configuration information indicates that the power connection configuration for the first standard cell is outside of a cell boundary of the first standard cell.

8. The first standard cell of claim 1, wherein the library of standards cells includes at least one variant of the first standard cell that is equivalent in function and drive strength to the first standard cell and includes cell configuration information for the variant of the first standard cell that provides a power configuration that is different from the power configuration of the first standard cell.

9. The first standard cell of claim 8, wherein the cell configuration information for the variant of the first standard cell indicates the power configuration to be inside a cell boundary of the variant of the first standard cell.

10. The first standard cell of claim 1, wherein the cell configuration information for the first standard cell indicates that one of the first edge or the second edge is configured as a dummy gate.

11. A Place and Route (PNR) library of standard cells, comprising:
a first standard cell comprising:
a cell boundary that includes a first edge and a second edge that is opposite the first edge; and
cell configuration information that indicates a power connection configuration to be used with a second standard cell of the PNR library of standard cells when the first standard cell is placed next to the second standard cell in a layout in a PNR environment, such that at least one transistor source electrode is physically shared between the first standard cell and the second standard cell.

12. The PNR library of standard cells of claim 11, wherein the cell configuration information indicates that the power connection configuration for at least one of the first edge and the second edge is outside the cell boundary for the first standard cell.

13. The PNR library of standard cells of claim 11, wherein the cell configuration information comprises edge identifier information for at least one of the first edge and the second edge of the first standard cell.

14. The PNR library of standard cells of claim 11, wherein when the first standard cell is placed in the layout in the PNR environment, a minimum distance between an outside edge of the first standard cell and an outside edge of the second standard cell is one Contacted Poly Pitch (CPP) for the shared power connection configuration.

15. The PNR library of standard cells of claim 11, wherein when the first standard cell is placed in the layout in the PNR environment, the cell boundary of the first standard cell abuts a cell boundary of the second standard cell.

16. The PNR library of standard cells of claim 11, wherein the cell configuration information indicates that the power connection configuration for at least one of the first edge and the second edge is inside a cell boundary for the second standard cell when the first standard cell is placed next to the second standard cell.

17. The PNR library of standard cells of claim 11, wherein the cell configuration information indicates that the power connection configuration for the first standard cell is outside of a cell boundary of the first standard cell.

18. The PNR library of standard cells of claim 11, wherein the library of standards cells further comprises at least one variant of the first standard cell that is equivalent in function and drive strength to the first standard cell and includes cell configuration information for the variant of the first standard cell that provides a power configuration that is different from the power configuration of the first standard cell.

19. The PNR library of standard cells of claim 18, wherein the cell configuration information for the variant of the first standard cell indicates the power configuration to be inside a cell boundary of the variant of the first standard cell.

20. The PNR library of standard cells of claim 11, wherein the cell configuration information for the first standard cell indicates that one of the first edge or the second edge is configured as a dummy gate.

21-30. (canceled)
